(19) United States
(12) Patent Application Publication
(10) Pub. No.: US 2017/0106276 A1
(43) Pub. Date: Apr. 20, 2017

(54) Method and Apparatus for Social Gaming

(71) Applicant: Saber Gaming Technologies, LLC, Maplewood, NJ (US)

(72) Inventor: Matthew Karch, Short Hills, NJ (US)

(73) Assignee: Saber Gaming Technologies, LLC, Maplewood, NJ (US)

(21) Appl. No.: 14/886,660

(22) Filed: Oct. 19, 2015

(51) Int. Cl. A63F 13/26; A63F 13/235; A63F 13/355; A63F 13/35

(52) U.S. Cl. CPC A63F 13/26; A63F 13/35; A63F 13/235; A63F 13/355

(57) ABSTRACT

A social gaming system includes a user device and main screen which communicate with a server via a network. Users download apps to play games on their user device when the user device is located in an establishment having a main screen. Various games can be played by a user using only the user device. Information concerning game play within the establishment, such as leader boards and game events, is displayed on the main screen. Users are awarded points for playing and/or winning games. The points can be redeemed for various awards such as free or reduced price food and beverages.

### BACKGROUND

The present disclosure relates generally to electronic games, and more particularly to social gaming.

Restaurants, bars, and other social gathering establishments continually look for new ways to distinguish themselves from their competition in order to attract more customers to their establishment. These establishments provide entertainment such as live bands or karaoke to attract customers. Typically, more customers result in more sales and profits for an establishment. As such, establishments continually seek new methods to attract customers to their establishment.

In addition to attracting new customers, many establishments strive to keep customers returning. The returning customers, together with new customers, allow an establishment to maintain a high level of profit. Distinguishing a particular establishment is particularly important when many other establishments offer similar services and products. As such, establishments are interested in using anything that can be used to attract new customers and keep existing customers returning.

Some establishments host games (e.g., trivia) to attract customers. However, most games require an establishment to assign one or more employees to host the games. In addition, these employees must keep track of player activity in order to fairly reward players for various achievements. Assigning employees to host events prevents those employees from performing other duties and lowers profits of establishment owners.

Establishments can have various floor plans. Not all floor plans are conducive to social games since there may not be enough room in a particular area for everyone who wants to play. As such, establishments may have to break game play up into rounds in order to allow all players a chance to play.

### SUMMARY

In one embodiment, a method for social gaming includes receiving game play and user information from a user device located in an establishment. A status of a game is determined based on the game play and user information. Data is transmitted to a main screen and the user device located in the establishment based on the determining. Game data transmitted to the user device facilitates play of the game via the user device without information displayed on the main screen. In one embodiment, user device information comprising a location of the user device is received and the establishment in which the user device is located is determined. A list of games available to play at the establishment is transmitted to the user device and user input from the user device is received identifying a game from the list of games that the user would like to play. In one embodiment, a number of points to be awarded to a user is determined based on the user's current game play and the points awarded to a user can be redeemed for items such as food or beverages. In one embodiment, data pertaining to an establishment is received and the data is transmitted to a user device. In one embodiment, user activity is tracked and information to transmit to the user device based on the user activity is determined and transmitted to the user device. In one embodiment, information for display on the main screen when games are not being played is transmitted.

### BRIEF DESCRIPTION OF THE DRAWINGS

FIG. 1 depicts a social gaming system according to one embodiment;

FIG. 2 depicts a user device according to one embodiment;

FIG. 3 depicts a main screen according to one embodiment;

FIGS. 4A and 4B depict a method for social gaming according to one embodiment; and

FIG. 5 depicts a high-level block diagram of a computer which can be used to implement a user device, server, and main screen.

### DETAILED DESCRIPTION

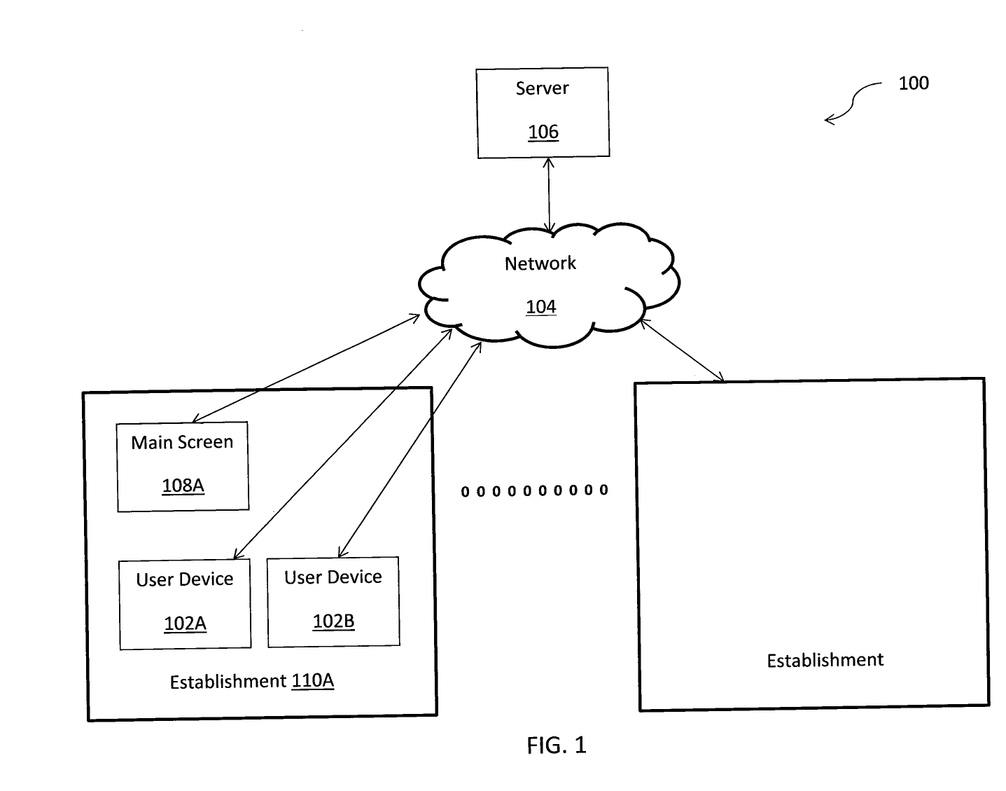

FIG. 1 depicts a social gaming system 100 comprising user devices 102A, 102B and main screen 108 in communication with server 106 via network 104. Main screen 108 and user devices 102A and 102B are located in establishment 110. Additional main screens and user devices in other establishments can also be in communication with server 106 via network 104. In one embodiment, a user plays a game on a user device (i.e., one of user devices 102A,102B) while visiting an establishment. In one embodiment, information concerning the game being played on a user device (such as user device 102A) is displayed via a main screen (such as main screen 108) located in an establishment (in this case, establishment 110). Server 106 is located remotely from main screen 108 and user devices 102A, 102B and, in one embodiment, remote from establishment 110. As such, from the viewpoint of main screen 108 and user device 102A, social gaming system 100 operates via cloud computing. In other embodiments, server 106 can be located within an establishment such as establishment 110.

In one embodiment, an establishment is a business such as a bar or restaurant. However, an establishment can be any geographic area in which one or more user devices are within a predefined distance from a main screen. As such, any area which can facilitate a social gathering can be an establishment.

Each of user devices 102A,102B can be any device capable of supporting an electronic game and communicating via network 104 with server 106. A user device, in one embodiment, is a handheld device such as a smart phone or tablet computer. A user device can be the visitor's personal device or can be provided to visitors of the establishment by the establishment to use during their visit. According to one embodiment, a computer program executed on a user device allows a user to play a game. Typical games include, for example, trivia, bingo, roulette, poker, blackjack, craps, name that tune, word guess, horse race, name the movie, word generation via tile placement type games, complete the lyrics, guess what the drawing represents, etc. In one embodiment, games loaded onto a user device only require the user device to be played by the user. For example, a user playing a game such as Bingo is provided with all information required to play the game via the user's user device. The player's bingo board and a display of all letter/number combinations previously drawn are displayed to the user via the user device. This means that a user does not have to use, view, or access a main screen to play a game.

In one embodiment, the main screen displays information about various games being played at the establishment as described in detail below. In one embodiment, multiple users play different games simultaneously via individual user devices. For example, two users in an establishment can play Bingo while three other users play trivia. In such embodiments, main screen 108 alternates displaying information for each of the two games.

Main screen 108 is in communication with user devices 102A and 102B and server 106 via network 104. In one embodiment, main screen 108 is a display such as a liquid crystal display television but can be any other type of display such as a cathode ray tube, light emitting diode television, organic light emitting diode display, tablet, etc. In one embodiment, main screen contains a processor and other hardware for communicating with server 106 and user devices 102A, 102B via network 104. In other embodiments, main screen 108 displays video and audio based on a signal from a source, such as a separate computer, which is in communication with user devices 102A, 102B and server 106 via network 104.

Operation of system 100, according to one embodiment, is as follows. A proprietor (or other user such as an employee) of the establishment in which main screen 108 is located downloads an application (also referred to as an “app”) to main screen 108 via an application downloading service or an application for downloading software. For example, the application can be downloaded via Apple's App Store, Google Play, or Amazon's Appstore for Android, etc. In one embodiment, main screen 108 is preloaded with software. After download, the app is installed and can be selected for operation on main screen 108 via user input. In one embodiment, main screen 108 comprises a touch screen for receiving user input. In other embodiments, other input devices such as a keyboard and a mouse are connected to main screen 108 and facilitate user input. In one embodiment, after selection, the app opens and a user is presented with an operation menu. The operation menu includes a selection which allows a user to select games that will be available to play at the establishment in which main screen 108 is located. Main screen 108 then transmits a list of the selected games to server 106 which provides the list to players located in the establishment in which main screen 108 is located.

Server 106 determines if any players have requested to play a game via their user devices such as user device 102A. If no users are currently playing or requesting to play a game, main screen 108 switches operation to demonstration mode. In one embodiment, demonstration mode causes main screen 108 to display various images and videos. For example, videos advertising the games available to play can be displayed while a user is in the establishment in which main screen 108 is located. Videos instructing users how to obtain the app required to play games on their user devices can be displayed as well. In addition, various additional information can be displayed such as specials the establishment is currently offering, events that will be held at the establishment, score boards depicting scores recent players achieved playing, etc.

In one embodiment, main screen 108 is connected to a computer that provides a display signal to main screen 108. In such embodiments, main screen 108 may not contain hardware and software to download, install, and execute apps. Accordingly, in such embodiments, the computer connected to main screen 108 contains hardware and software to download, install, and execute apps and communicate with main screen 108 and server 106 via network 104.

A user associated with user device 102A downloads an application (also referred to as an “app”) via an application downloading service or app for downloading software similar to the manner described above in conjunction with main screen 108. For example, the application can be downloaded via Apple's App Store, Google Play, or Amazon's Appstore for Android, etc. After downloading is completed, the app is installed and can be selected for operation on user device 102A via user input. It should be noted that, in one embodiment, user device 102A is preloaded with the app. In one embodiment, after selection, the app opens and begins gathering information. In one embodiment, the app determines the location of user device 102A in order to determine if user device 102A is located in or near an establishment that supports social game play. In one embodiment, user device 102A transmits location information along with identification information to server 106 via network 104. Server 106 compares the location of user device 102A with locations associated with establishments that support game play (such as establishments 110). In response to determining that user device 102A is located in an establishment that offers social game play (in this example, establishment 110), server 106 transmits a list of games that establishment 110 is currently offering for play. In response to a user selecting one of the games from the list of games offered for play, user device 102A transmits the user's game selection to server 106 via network 104.

In one embodiment, game play is facilitated by user device 102A communicating with server 106 via network 104 and main screen 108 receives game play information from server 106 via network 104. Communication between user device 102A, server 106, and main screen 108 via network 104 is referred to as operation via the cloud. In one embodiment, operation of the system is facilitated by server 106 which is in communication with user device 102A and main screen 108 and performs necessary computations to facilitate gameplay. For example, in one embodiment, user device 102A and main screen 108 are used as display devices with user device 102A additionally being capable of receiving user input. Game play is facilitated by server 106 and game information is transmitted from server 106 to user device 102A and main screen 108 via network 104. In one embodiment, user device 102A and main screen 108 operate in a manner similar to a dumb terminal. That is, most computations concerning gameplay are performed by server 106 and

In one embodiment, a game can be played using only a user device and a view of a main screen is not required. For example, if a user is playing trivia, the user can play the game using only user device 102A. All questions and possible answers are displayed to the user via user device 102A. Main screen 108 displays information about games currently being played and is not required to play the games. For example, main screen 108 displays leader boards depicting scores of various players playing games at the establishment in which main screen 108 is located. Main screen 108 can also depict various details of games currently being played. For example, the results of players' answers to a question may be displayed on main screen 108. Details of games vary based on the type of game being played. For example, if players are playing bingo, each player can play the game using only their user device. All information required for the player to play the game, such as the bingo card and a list of letter/number combinations previously drawn, is displayed via the user device. Main screen 108 can display information about game play. For example, a graphic of a Bingo ball can be displayed in response to a letter/number combination displayed on the ball being drawn. In addition, if a player has completed a designated pattern on their bingo card, the word “BINGO” can be displayed on main screen 108. Main screen 108 can also display other information such as advertisements, upcoming events, specials, menus, etc.

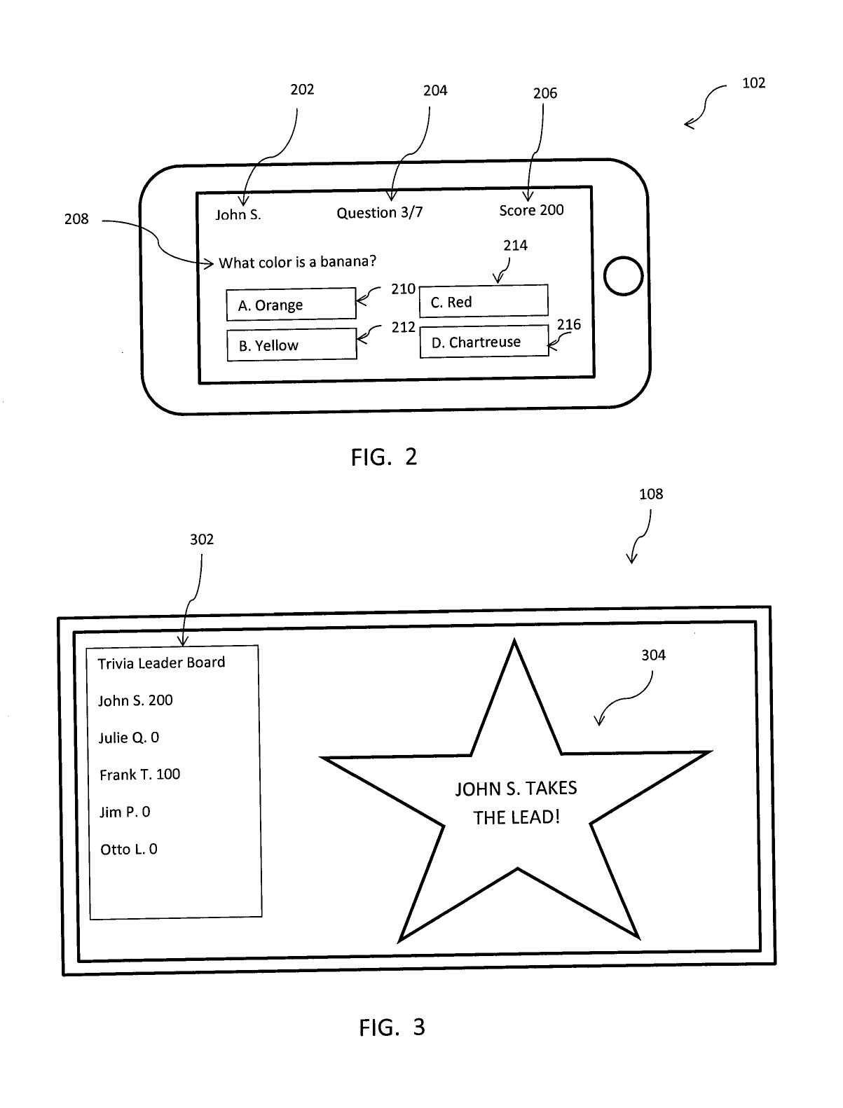

FIG. 2 depicts user device 102A according to one embodiment in which a user is playing a game. As shown in FIG. 2, user identification 202 indicates that John S. is playing. Question number identifier 204 indicates that question 3 of 7 is currently being asked. Score identifier 206 indicates that the player currently has a score of 200. Question 208 identifies the question a player currently has to answer and answers 210, 212, 214, and 216 list the answers from which the player can choose. In one embodiment, a user selects one of answers 210, 212, 214, and 216 and the selection, along with user identification, is transmitted to server 106. Server 106 receives answers and user identification from other players as well and transmits information to update information displayed on main screen 108.

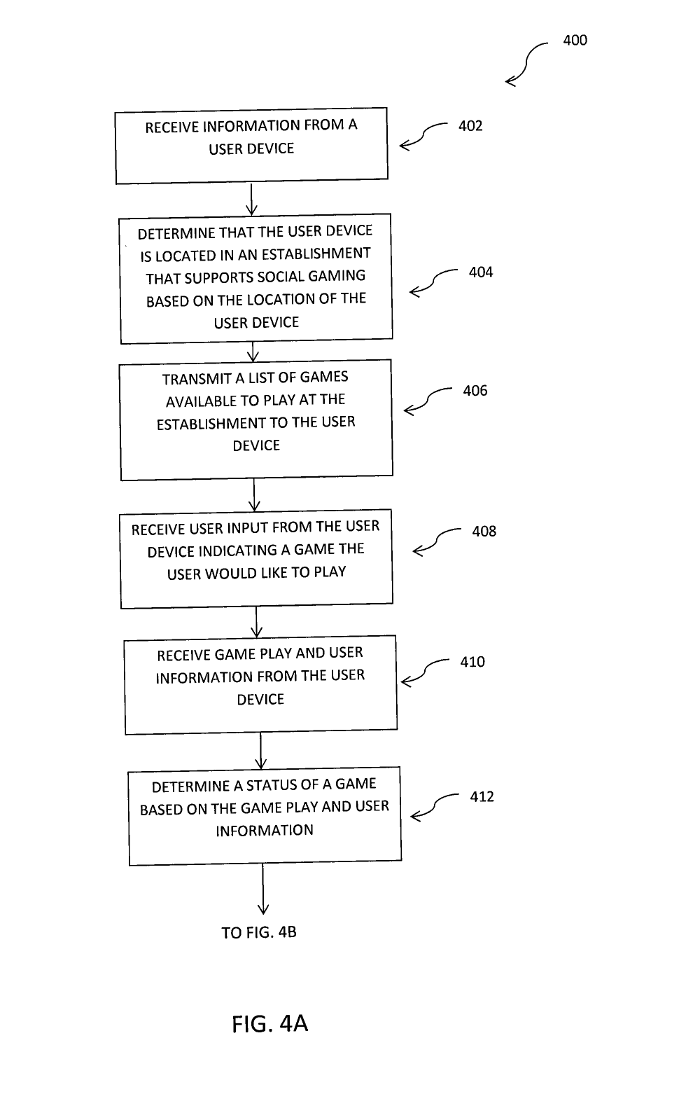

FIG. 3 depicts main screen 108 according to one embodiment. As shown in FIG. 3, main screen 108 displays leader board 302 which displays multiple players' scores. In one embodiment, all players' scores are depicted. In other embodiments, only the scores of players having the top X scores are displayed. For example, the top ten scores can be displayed on leaderboard 302. In one embodiment, additional information about the details of a particular game can be displayed on main screen 108. As shown in FIG. 3, a star 304 with the text “JOHN S. TAKES THE LEAD!” is displayed indicating activity during a particular game. Other information can be displayed on main screen 108 as well based on the games being played in the establishment in which main screen 108 is located. For example, if one or more users are playing Bingo, main screen 108 can display a list of letter/number combinations previously drawn. As previously noted, the information displayed on main screen 108 is not necessary for user's to play the game. In this example, although main screen 108 displays the list of letter/number combinations previously drawn, the list displayed on main screen 108 is not required by a user since the user device associated with the user displays the list of letter/number combinations previously drawn in addition to the user's Bingo card.

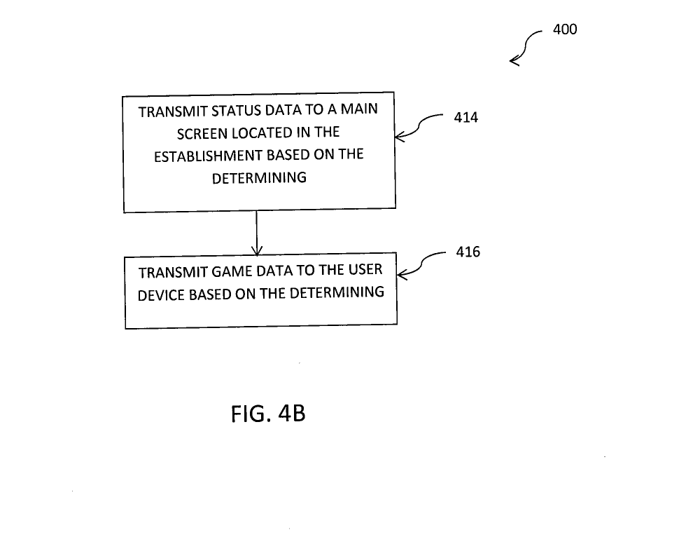

FIGS. 4A and 4B depict a method 400 for social gaming according to one embodiment implemented on server 106 (shown in FIG. 1). As shown in FIG. 4A, at step 402, server 106 receives user device information from a user device (such as user device 102A shown in FIG. 1). The user device information comprises a location of the user device. At step 404, server 106 determines that the user device is located in an establishment which supports social gaming based on the location of the user device. At step 406, server 106 transmits a list of games available to play at the establishment. In one embodiment, the list of games available to play at the establishment is based on games selected by a proprietor (or other user such as an employee of the establishment) via main screen 108. At step 408, server 106 receives user input from the user device identifying a game from the list of games that a user associated with user device would like to play. Server 106 then prepares to receive game play information from the user device and the user device presents the game to the user for play. At step 410, server 106 receives game play and user information from the user device. For example, a user's answer to a trivia question can be transmitted from the user device to server 106 along with user identification in response to a user selecting an answer. At step 412, server 106 determines a status of the game based on the game play and user information. For example, server 106 can determine that user John S. has just taken the lead in a trivia game. At step 414 shown in FIG. 4B, in response to the determining, server 106 transmits data to main screen 108 located in the establishment. Main screen 108 can then display this information as shown in FIG. 3.

The method continues in FIG. 4B where, at step 416, server 106 transmits game data to the user device based on the determining of step 414.

In one embodiment, server 106 determines whether a player has won the game being played. Once a game has ended, server 106 determines a number of points that a winning player will be given and awards the points to the winging player. Points can be redeemed by the winning player for various items. For example, a user may be eligible to receive a free beverage after a specific number of points have been earned by winning. In one embodiment, players may be awarded points for playing games regardless of whether they win games.

In one embodiment, a user can search for nearby establishments that offer social game play via a user device (such as user device 102A shown in FIG. 1). For example, a user can select an option to find establishments near the location of the user device in order to determine nearby establishments that provide social game play. In response, the user device queries server 106 to determine nearby establishments that offer social game play based on the current location of the user device. In response, server 106 transmits a list of nearby establishments that offer social game play. In addition, links to websites of the establishments, lists of specials, menus, events, etc. can be transmitted from server 106 to the user device in order to provide a user with additional information to decide where the user would like to go.

Server 106, in addition to supporting game play, also tracks user information and activities. For example, a user's location, game play history, point and award history, duration played, number of games played, type of games played, coupons used, demographic information (e.g., age, sex, etc.) weather information (e.g., temperature, precipitation, etc.), national and local events, television broadcast schedules, etc. Any information that may assist an establishment in maximizing the number of patrons visiting the establishment may be tracked and analyzed.

In one embodiment, users are incentivized to play games by giving points and awards to various users. For example, users who win games or rounds within games can be awarded points which can be redeemed for various awards such as free or discounted food and/or beverages. In one embodiment, points can be redeemed for products, services or merchandise. For example, users can redeem points for a variety of items such as televisions, tablets, travel, etc. Server 106 tracks user game play and points accrual.

In one embodiment, advertisements and other information can be pushed from server 106 to a user device (such as user device 102A shown in FIG. 1). For example, coupons, event notifications, and other information can be pushed from server 106 to the user device via network 104. In one embodiment, information is pushed to the user device based on the location of the user device. For example, an advertisement for an event at a nearby establishment can be pushed to the user device when the user device is currently located near the establishment.

In one embodiment, players are required to sign in in order to receive points for gameplay. Users who do not wish to sign in may still play games while in an establishment but will not be able to earn points. In one embodiment, the app on user device 102 is configured to display ads while a user is playing a game. The ads can be displayed between rounds, between games, or during games. Ads displayed during games may be positioned so as to be noticed but not interfere with gameplay. In one embodiment, ads are displayed on user devices operating a free app while ads are not displayed to users operating a premium app. In one embodiment, users watching ads can be rewarded with points or other awards.

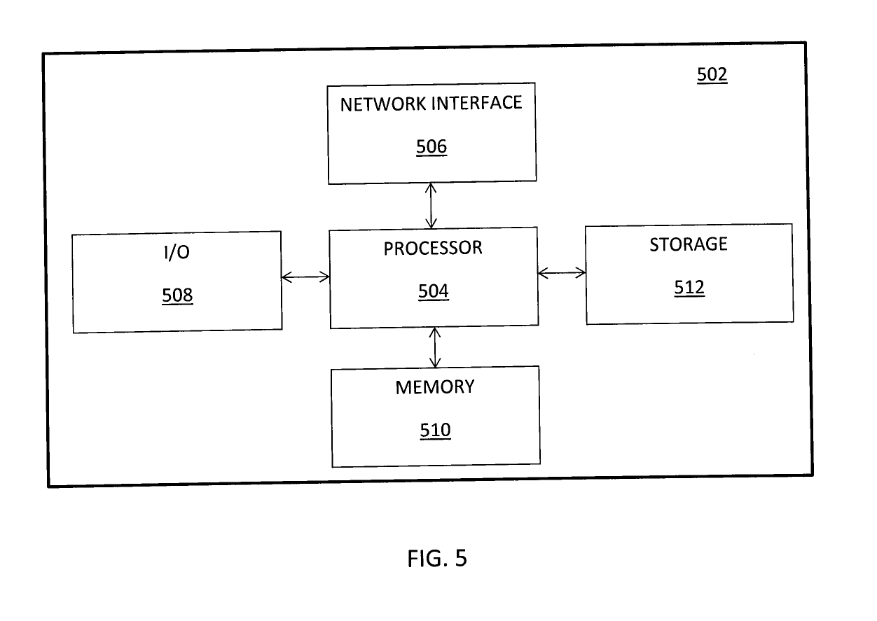

User device (such as user devices 102A,102B shown in FIG. 1), server 106, and main screen 108 can each be implemented using a computer. A high-level block diagram of such a computer is illustrated in FIG. 5. Computer 502 contains a processor 504 which controls the overall operation of the computer 502 by executing computer program instructions which define such operation. The computer program instructions may be stored in a storage device 512, or other computer readable medium (e.g., magnetic disk, CD ROM, etc.), and loaded into memory 510 when execution of the computer program instructions is desired. Thus, the method steps of FIGS. 4A and 4B can be defined by the computer program instructions stored in the memory 510 and/or storage 512 and controlled by the processor 504 executing the computer program instructions. For example, the computer program instructions can be implemented as computer executable code programmed by one skilled in the art to perform an algorithm defined by the method steps of FIGS. 4A and 4B. Accordingly, by executing the computer program instructions, the processor 504 executes an algorithm defined by the method steps of FIGS. 4A and 4B. The computer 502 also includes one or more network interfaces 506 for communicating with other devices via a network. The computer 502 also includes input/output devices 508 that enable user interaction with the computer 502 (e.g., display, keyboard, mouse, speakers, buttons, etc.) One skilled in the art will recognize that an implementation of an actual computer could contain other components as well, and that FIG. 5 is a high level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method for social gaming comprising:
receiving game play and user information from a user device located in an establishment;
determining a status of a game based on the game play and user information;
transmitting status data to a main screen located in the establishment based on the determining, the status data for displaying information relating to the game; and
transmitting game data to the user device based on the determining, the game data facilitating play of the game via the user device without the need for information displayed on the main screen.

2. The method of claim 1 further comprising:
receiving user device information from the user device, the user device information comprising a location of the user device; and
determining the establishment in which the user device is located based on the location of the device.

3. The method of claim 1 further comprising:
transmitting a list of games available to play at the establishment to the user device, the list of games defined by a user associated with the establishment; and
receiving input from the user device identifying a game from the list of games that a user associated with the user device would like to play.

4. The method of claim 1 further comprising:
transmitting advertising information for display on the main screen when games are not being played.

5. The method of claim 4 wherein the advertising information is based on user information associated with one or more users currently in the establishment.

6. The method of claim 1 further comprising:
receiving data pertaining to an establishment; and
transmitting the data pertaining to the establishment to the user device.

7. The method of claim 1 further comprising:
tracking user activity associated with the user device; and
determining advertising information to transmit to the user device based on user activity; and
transmitting the advertising information to the user device.

8. An apparatus comprising:
a processor; and
a memory to store computer program instructions, the computer program instructions when executed on the processor cause the processor to perform operations comprising:
receiving game play and user information from a user device located in an establishment;
determining a status of a game based on the game play and user information;
transmitting status data to a main screen located in the establishment based on the determining, the status data for displaying information relating to the game; and
transmitting game data to the user device based on the determining, the game data facilitating play of the game via the user device without the need for information displayed on the main screen.

9. The apparatus of claim 8, the operations further comprising:
receiving user device information from the user device, the user device information comprising a location of the user device; and
determining the establishment in which the user device is located based on the location of the device.

10. The apparatus of claim 8, the operations further comprising:
transmitting a list of games available to play at the establishment to the user device, the list of games defined by a user associated with the establishment; and
receiving input from the user device identifying a game from the list of games that a user associated with the user device would like to play.

11. The apparatus of claim 8, the operations further comprising:
transmitting advertising information for display on the main screen when games are not being played.

12. The apparatus of claim 11 wherein the advertising information is based on user information associated with one or more users currently in the establishment.

13. The apparatus of claim 8, the operations further comprising:
receiving data pertaining to an establishment; and
transmitting the data pertaining to the establishment to the user device.

14. The apparatus of claim 8, the operations further comprising:
tracking user activity associated with the user device; and
determining advertising information to transmit to the user device based on user activity; and
transmitting the advertising information to the user device.

15. A computer readable medium storing computer program instructions for doing social gaming, which, when executed on a processor, cause the processor to perform operations comprising:
receiving game play and user information from a user device located in an establishment;
determining a status of a game based on the game play and user information;
transmitting status data to a main screen located in the establishment based on the determining, the status data for displaying information relating to the game; and
transmitting game data to the user device based on the determining, the game data facilitating play of the game via the user device without the need for information displayed on the main screen.

16. The computer readable medium of claim 15, the operations further comprising:
receiving user device information from the user device, the user device information comprising a location of the user device; and
determining the establishment in which the user device is located based on the location of the device.

17. The computer readable medium of claim 15, the operations further comprising:
transmitting a list of games available to play at the establishment to the user device, the list of games defined by a user associated with the establishment; and
receiving input from the user device identifying a game from the list of games that a user associated with the user device would like to play.

18. The computer readable medium of claim 15, the operations further comprising:
transmitting advertising information for display on the main screen when games are not being played.

19. The computer readable medium of claim 18, wherein the advertising information is based on user information associated with one or more users currently in the establishment.

20. The computer readable medium of claim 15, the operations further comprising:
receiving data pertaining to an establishment; and
transmitting the data pertaining to the establishment to the user device.
